(19) United States
(12) Patent Application Publication
(10) Pub. No.: US 2011/0218870 A1
(43) Pub. Date: Sep. 8, 2011

(54) COMMUNICATION METHOD FOR A ROAMING POINT-OF-SALE SYSTEM

(75) Inventors: Khawaja Shams, Milpitas, CA (US); Michael Maysmith, Cupertino, CA (US)

(73) Assignee: Apple Inc., Cupertino, CA (US)

(21) Appl. No.: 12/782,947

(22) Filed: May 19, 2010

Related U.S. Application Data
(60) Provisional application No. 61/311,739, filed on Mar. 8, 2010.

(51) Int. Cl. G06Q 30/00; G06K 7/10

(52) U.S. Cl. 705/17; 705/23; 235/383; 235/380; 235/462.01

(57) ABSTRACT

A roaming point-of-sale system is disclosed including methods of communicating between the system components. A handheld computing device sends messages to a scanning device, which messages cause the scanning device to scan and return barcode data from a barcode scanner and payment card information from a magnetic strip reader. The messages include a header and a message, and the header designates the command given and the size of the message, among other useful information.

### CROSS REFERENCE TO RELATED APPLICATIONS

This application claims the benefit of U.S. Provisional Patent Application No. 61/311,739, entitled “COMMUNICATION METHOD FOR A ROAMING POINT-OF-SALE SYSTEM”, filed on Mar. 8, 2010, and which is hereby expressly incorporated herein by reference in its entirety.

### FIELD

The following relates to point-of-sale systems, and more particularly to roaming point-of-sale systems.

### BACKGROUND

In a store, there are often many sales associates out “on the floor” meeting with customers, answering questions, etc. Eventually, though, when a customer decides to make a purchase the customer takes the item to a central point-of-sale location, where there is a cash register and barcode scanner which are linked to a pricing database, a credit card reader, etc.

While this arrangement is generally sufficient, it is not always so. For example, during busy periods, this centralized arrangement can cause “bottlenecks” and unpleasant lines at the checkout counter. If a line is too long, a customer may decide make his to purchase elsewhere or even not at all. Alternatively, if during regular, non-busy periods, the time it takes for the customer to walk from the display to the point-of-sale location gives the customer an opportunity to decide not to make the purchase, and this may be particular true with respect to non-essential and/or impulse purchases.

### SUMMARY

To overcome such potential drawbacks of a centralized point-of-sale arrangement, a point-of-sale system is disclosed that includes a handheld computing device and a portable scanner. The handheld computing device can be used to complete a sales transaction based at least on data received from the portable scanner and data input into the handheld computing device. The handheld computing device can be, for example, a mobile phone, such as the IPHONE, a smartphone, or a portable media player, such as an IPOD TOUCH. Both the IPHONE and IPOD TOUCH are sold by Apple, Inc. of Cupertino, Calif. The portable scanning device can be a barcode scanner configured to operate with the handheld computing device. In some embodiments, the portable scanning device is configured to receive the handheld computing device in a dock to facilitate communication therewith. In some embodiments, the portable scanner also includes a magnetic strip reader.

In one method of operation, the handheld computing device can execute a sales application, which has a graphical user interface that guides a sales associate through a sales transaction. For example, the sales application can instruct the sales associate to scan a barcode on an item to be purchased. In some embodiments, the sales application can require an input from an input device, e.g. a button or touchscreen, before sending a barcode-scan command to the scanning device. Upon receiving the barcode-scan command, the scanning device can issue a response message indicating that it has received the command. The scanning device can initiate its barcode-scan device and read and decode any scanned barcode(s). The scanned barcode(s) information can be formatted into a message having a header and appended message to report the decoded barcode data back to the handheld computing device.

Upon receiving the decoded barcode data, the scanning device can process the decoded barcode data according to the instruction provided by the sales application and submit the decoded barcode data into a sales form that is part of the sales application. In most cases the decoded barcode data corresponds to a product code, which can be used to retrieve product information from an in-store server. The product information can include any information useful, or needed to complete a sales transaction, e.g. price information, name of the product, etc. The sales form can be used for printing a receipt, or keeping a record of the transaction.

In some embodiments, either the sales program or the user (by issuing a command using an input device) can cause the sales program to send a command to the scanning device to scan payment information. In a manner similar to the barcode scan command sent from the handheld computing device, the scanning device can return either a confirmation message, which confirms to the handheld computing device that the command was received, or it can return the data immediately. The scanning device receives the payment information data by initiating reading by a magnetic strip reader to read payment card information. The payment card data is sent back to the handheld computing device and the sales application processes the payment card information. The processed information can be input into the sales form.

The sales form including the payment card information can be sent to an in-store server to record the transaction. The in-store server can also process the payment information in conjunction with a financial clearinghouse to approve the transaction. In some embodiments, the handheld computing device can communicate directly with the clearinghouse to approve the transaction. The information regarding the transaction, which includes at least the payment card information, but can also include other information associated with the transaction from the payment clearinghouse can be input into the sales form as transaction information and sent to the in-store server.

Additionally, a format for communications between a scanning device and a handheld computing is disclosed. Electronic messages sent between the scanning device and the handheld computing device can include headers with data fields containing data identifying a device, data designating a command, data denoting a message size, and data identifying a message identification number along with an appended message. The appended message can include data associated with the command designated by header data, and be of the size denoted by the header data.

A variety of messages used in communication between a handheld computing device and a scanning device are disclosed. The messages include at least configuration messages, status messages, and command messages.

### BRIEF DESCRIPTION OF THE DRAWINGS

FIG. 1 is an exemplary schematic perspective view of a roaming point of sale device;

FIG. 2 is a schematic illustration of an exemplary point-of-sale system;

FIG. 3 illustrates an exemplary message structure that can be used in the point-of-sale system described herein;

FIG. 4 illustrates an exemplary scanning operation;

FIG. 5 illustrates an exemplary sales form that can be displayed on a handheld computing device;

FIG. 6 illustrates an exemplary method embodiment for scanning multiple codes types and storing the codes in a sales form; and

FIG. 7 is a schematic illustration of an exemplary system embodiment of the handheld computing device and/or the scanning device.

### DESCRIPTION

The technology described herein relates to a roaming point-of-sale system wherein a handheld computing device and a scanner device are joined in electronic communication and can be used anywhere within a retail store to complete a sales transaction.

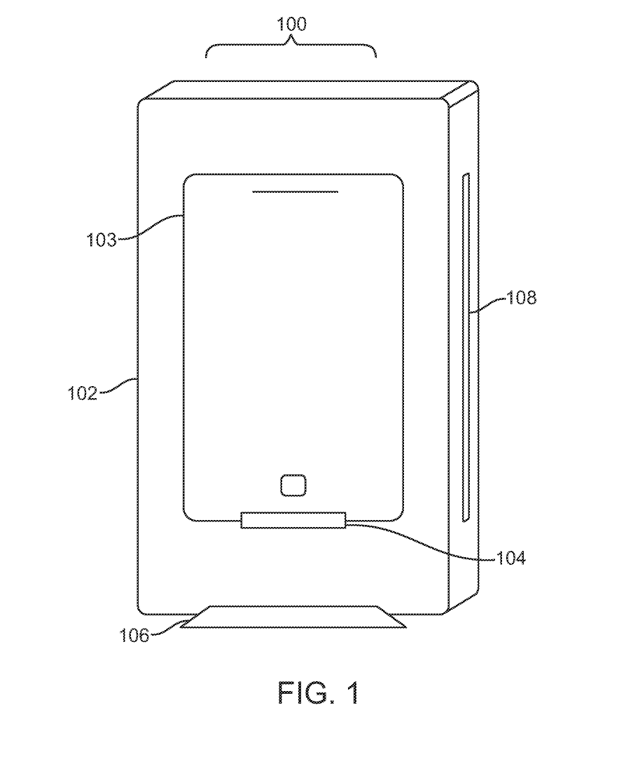

FIG. 1 illustrates an exemplary roaming point-of-sale system 100, which includes a scanning device 102 and a handheld computing device 103, which can fit into a cavity in the scanning device in a docking arrangement. As illustrated, the handheld computing device can be received in the cavity of scanning device in such a configuration that gives the appearance that the system is one integral device.

The scanning device 102 includes a barcode scanner 106 and in some embodiments the scanning device can have a magnetic card reader 108, as illustrated. However, in other embodiments, the barcode scanner 106 and the magnetic card reader 108 can be physically distinct devices. As illustrated, the handheld computing device 103 and the scanning device 102 are in electrical communication via connector 104. The connector 104 can be any connection that is able to establish electrical communication between the scanning device 102 and the handheld computing device, but it is especially forseen as being an universal serial bus connector or a 30-pin connector such as is most commonly found on an IPOD TOUCH portable media-playing devices or an IPHONE smartphone, both of which are sold by Apple Inc. of Cupertino, Calif.

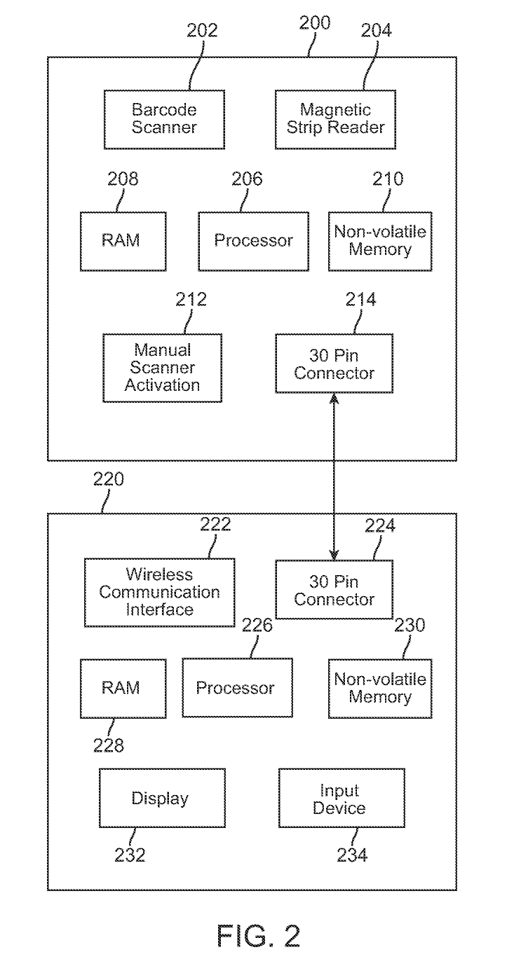

FIG. 2 schematically illustrates a roaming point-of-sale system, which includes a scanning device 200 and a handheld computing device component 220. The handheld computing device includes an input device 234, which is operable to receive an input from a sales associate using the input device 234. The input device can be a keypad and or pointing device, or, as in preferred embodiments, a touch sensitive display. The handheld computing device 220 also includes a processor 226. The processor 226 is configured to load and/or run a point-of-sale application, usually as a result of receiving an input from the input device 234.

The point-of-sale application can be loaded from a storage device 230, which can be any suitable non-volatile memory, into a RAM 228 for use by the processor 226. As directed by the point-of-sale application, the processor 226 sends a barcode-scan command to the scanning device 200 via the 30-pin connectors 214, 224.

Processor 206 receives the barcode-scan command, which is interpreted in the context of computer-executable instructions (firmware) already loaded in RAM 208. When not in use the computer-executable instructions (firmware) are stored in non-volatile memory 210.

In response to the barcode-scan command, the barcode scanner 202 scans barcodes and processor 206 receives the scanned data and decodes the barcode information and sends the decoded data to the handheld computing device using the connector 214. In some embodiments, the barcode scanner can be manually activated by a manual scanner activation button 412, which also causes the scanning device to scan and decode the barcodes and send the decoded data to the handheld computing device. The data is received by the handheld computing device using its connector 224, which identifies the received code and sends it to RAM 228 for temporary storage in association with the sales application.

The sales application can also instruct the processor 226 to present an on the display 232 showing the progress of the transaction. At this stage, the display can identify the product being purchased based on the scan information and can also prompt the sales associate to enter payment information.

The processor 226 can send a receive-payment instruction over connectors 224 and 214 to the scanner processor 206 in response to either a user-initiated instruction or an instruction given by the sales application. After receiving the receive-payment instruction, the processor 206 can interpret the instruction based on firmware and receive data from a magnetic strip reader 204. The magnetic strip reader 204 is used to accept credit card or bankcard data by reading the magnetic strip that is commonly located on the backs of such cards. The magnetic strip reader 204 passes the received data on to the processor 206, which sends the data back to the handheld computing device. The processor 226 receives the magnetic strip data and sends the data to RAM 228 for temporary storage in association with the sales program.

The transaction is completed by transmitting payment information to a payment clearinghouse and receiving a payment confirmation therefrom. The handheld communication device can transmit the payment information using the wireless communication interface 222, over a network, to the payment clearinghouse. After a payment confirmation is received from the payment clearinghouse, a record of the entire transaction including any product information, customer information, and payment information is completed and sent to an in-store server using the wireless communication interface 222.

In some embodiments, the roaming point-of-sale system utilizes a handheld computing device that is generally not manufactured specifically for use in connection with in the roaming point-of-sale system. Rather, the handheld computing device can be a more general purpose device with a sales application installed on it to allow the device to be used with the scanner that is specially designed for use in connection with in the roaming point-of-sale system. The handheld computing device suitably will have many other functions, e.g., as a mobile phone, as a portable media-playing device, as an email client, as a game-playing device, as a personal organizer, etc. However, because the handheld-computing device is not a specific purpose device, the scanner and handheld-computing device must be configured to electronically communicate with each other. A method or protocol for such communication is herein described.

Table 1, below, provides an exemplary list of commands that can be communicated between the handheld computing device and the scanner, and the associated binary and hexadecimal codes representing the commands.

TABLE 1

| ID | Command Name | Binary | Hex |
|---|---|---|---|
| 0 | cs.scanner.no-op | 0000 | 00 |
| 1 | scanner.cs.powerUpNotification | 0001 | 01 |
| 2 | cs.scanner.powerCycle | 0010 | 02 |
| 3 | cs.scanner.startScan | 0011 | 03 |
| 4 | cs.scanner.stopScan | 0100 | 04 |
| 5 | scanner.cs.scannedData | 0101 | 05 |
| 6 | scanner.cs.scannerButtonState | 0110 | 06 |
| 7 | cs.scanner.config.scannerTimeOut | 0111 | 07 |
| 8 | cs.scanner.config.scanTimeOut | 1000 | 08 |
| 9 | cs.scanner.config.scanMode | 1001 | 09 |
| 10 | cs.scanner.config.scanButtonState | 1010 | 0A |
| 11 | cs.scanner.config.beep | 1011 | 0B |
| 12 | cs.scanner.config.barCodeType | 1100 | 0C |
| 13 | cs.scanner.status.firmwareVersion | 1101 | 0D |
| 14 | cs.scanner.status.battery | 1110 | 0E |

Table 1 is not an exclusive or exhaustive list of commands. For example, additional commands that can be used in conjunction with the present technology include commands to operate the magnetic-strip reader and commands to cause the scanner to update its firmware with data sent from the handheld computing device.

Each command name is represented using the same naming convention. The device sending the message is identified first; the device receiving the command is identified second; and the command is identified last in the naming convention, with each value being separated by a period.

Table 2, below, provides an exemplary list of handheld-computing devices, scanning devices, and the associated binary and hexadecimal codes identifying those devices.

TABLE 2

| | Device | Binary | Hex |
|---|---|---|---|
| 1 | SmartPhone | 0000 | 00 |
| 2 | Portable Multimedia | 0001 | 01 |
| | playing | | |
| | device | | |
| 3 | Scanner | 0010 | 02 |

Table 3, below, provides an exemplary list of response status codes and their associated binary and hexadecimal codes, which are most commonly sent from the scanner to the handheld computing device in response to some commands.

TABLE 3

| Description | Bit | Binary | Hex |
|---|---|---|---|
| Error | 0 | 0001 | 01 |
| Scanner button is pressed | 1 | 0010 | 02 |
| Auto Answer | 2 | 0100 | 04 |
| Part of Multi Frame | 3 | 1000 | 08 |

The error code can be responsive to any command and is indicative or some error. In some embodiments of the use of the error status message, an error status indicates that there was an error in performing the command to which the message containing the error status code is responsive. In some embodiments of the use of the error status message, the error status can be sent based on any error that occurred on either the scanning device or the handheld computing device.

The scanner-button-is-pressed status is sent to indicate that a button is depressed on the scanning device. The button used to initiate a scanning operation by use of hardware, i.e., the button. This status can be returned responsive to any message, but is most meaningful when either returned in response to a command to initiate scanning, or in a message originating at the scanning device that contains barcode information. In the latter instance, a user could hold down the scanner button and scan barcodes. The scanning device can transmit data representing these values to portable computing device. Upon receiving the message, the portable computing device can learn that a user holding the scanner button did not scan these codes in error, but intentionally. The handheld scanning device can record the barcodes in a sale form.

The auto-answer status can be reported in messages confirming receipt of commands sent from the handheld computing device to the scanning device, or vice versa. The auto-answer status indicates that the answering device is configured to confirm receipt of received commands.

The part-of-multiframe status indicates that the message containing this status is being sent across several different messages. It can be used to send data that is too large or inconvenient to be sent in one message and thus it is broken into several.

Table 4, below, provides an exemplary list of barcodes that can be scanned and recognized by the barcode scanner and their associated hexadecimal codes.

TABLE 4

| | Barcode Type | Hex |
|---|---|---|
| 0 | All Barcode Types | 00 |
| | Supported Enabled | |
| 1 | U.P.C. | 01 |
| 2 | Codabar | 02 |
| 3 | Code 25 - Non-interleaved | 03 |
| | 2 of 5 | |
| 4 | Code 25 - Interleaved 2 of 5 | 04 |
| 5 | Code 39 | 05 |
| 6 | Code 93 | 06 |
| 7 | Code 128 | 07 |
| 8 | Code 11 | 08 |
| 9 | CPC Binary | 09 |
| 10 | DUN 14 | 0A |
| 11 | EAN 2 | 0B |
| 12 | EAN 5 | 0C |
| 13 | EAN 8 | 0D |
| 14 | EAN13 | 0E |
| 15 | GS1-128 (formerly known | 0F |
| | as UCC/EAN-128) | |
| 16 | GS1 DataBar | 10 |
| 17 | ITF.14 | 11 |
| 18 | Latent image barcode | 12 |
| 19 | Pharmacode | 13 |
| 20 | PLANET | 14 |
| 21 | POSTNET | 15 |
| 22 | Intelligent Mail Barcode | 16 |
| 23 | MSI | 17 |
| 24 | PostBar | 18 |
| 25 | RM4SCC/KIX | 19 |
| 26 | Telepen | 1A |
| 27 | Plessey | 1B |

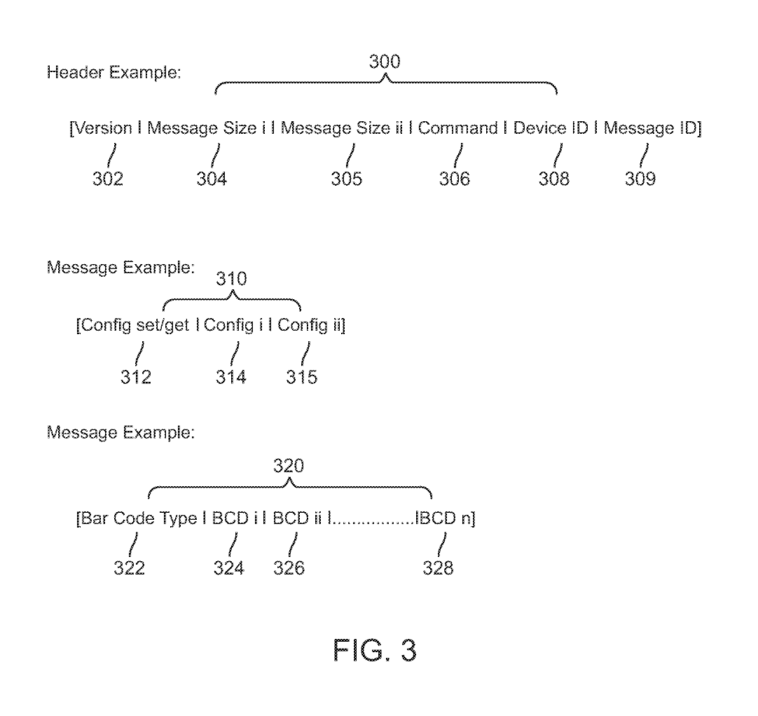

Tables 1-4 each present exemplary values, corresponding to instructions or other data, sent between the handheld computing device and the scanning device. For example, in FIG. 3 an exemplary header 300 for use in electronically communicating between the handheld computing device and the scanning device is illustrated. Header 300 illustrates the organization of the electronic messages to be exchanged between the handheld computing device and the scanning device. Each of the fields, Version 302, Message Size i 304, Message Size ii 305, Command 306, Device 308, and Message ID 309 are one byte.

The Version field 302 denotes the version number of the software. It is used to confirm that the handheld computing device and the scanning device are communicating using a protocol version that it is configured to accept.

The Message Size i field 304 and Message Size ii field 305 each denote the size of the following message. As each header field is of a limited size, e.g., 1 byte, some messages will be too big to represent using only the Message Size i field 304. Therefore for larger messages, the Message Size ii field 305 can also be used. Therefore, larger numbers corresponding to larger messages can be indicated. By indicating the message size, the receiving device can learn of the size of the message and use that information to determine if the complete message was received by comparing the received bytes to the expected bytes listed in fields 304 and 305.

The Command field 306 contains commands such as those represented in Table 1, above, and other commands that can be sent between the handheld computing device and the scanning device.

The Device ID field 308 identifies the device sending the message as is represented in Table 2, above. The field identifies the handheld computing device model or scanner model that is used to send the message. However, in some embodiments of the protocol, the field can be used to always identify the device that originally issued the command. In such embodiments, a responsive message would not indicate the device sending the message, but would indicate the device that issued the original message to which is being responded.

The Message ID field 309 identifies an original message. For example, when a command is sent from the handheld computing device, it can be designated as message 1 by indicating that value the Message ID field 309. When the scanning device responds to that message, it can maintain the same message ID so that the handheld computing device will associate the communication as a response to the original message. Each original message should have a unique message ID. In some embodiments, the message ID can be repeated only after a transaction is completed or after of one of the devices performs a power recycle.

Following the header is a message of a size matching the size indicated in field 304 or, for larger messages, fields 304 and 305 combined. Messages 310 and 320 are exemplary messages. Message 310 is a configuration message and, as illustrated, can be either a get-configuration command or a set-configuration command 312. After the command, the configuration data follows in fields 314 and 315. Likewise, message 320 is a barcode-type command 322 and after the command the first barcode type is designated in field 324, the second barcode type is designated in field 326, and each successive barcode is designated in the following fields 328.

Table 5 illustrates an exemplary no-op command message. As represented, the no-op command message is in hexadecimal format, and indicates that the software is version 0. The no-op command, cs.scanner.no-op, taken from table 1, is designated in hexadecimal format as 00. Further, the command has no message size; only the header is required for this command. The command is sent from a portable multimedia-playing device and the message is designated as message ID 01. The no-op command can serve to either as a ping-type command that can be used to confirm that the scanning device is present or to keep the scanning device from going to sleep. In summary, the command determines if the scanning device is present and ready to receive additional commands.

TABLE 5

| | Message | Message | | | |
|---|---|---|---|---|---|
| Version | Size I | Size II | Command | Device ID | MessageID |
| 00 | 00 | 00 | 00 | 01 | 01 |

Table 6 illustrates a response to the no-op command, which is sent from the scanning device to the handheld computing device. The scanning device is represented by the value 02 in the Device ID field 308. As with the original command, no message accompanies the header as indicated by the 00 bytes represented in the message size fields. The MessageID field indicates that this message is a response to MessageID 01. Further, status code fields are provided but, in this example, no status is provided. If a status were applicable, one of the codes represented in table 3 could be represented in these fields. The no-op command response informs the handheld device that the scanner is present and ready for operation.

TABLE 6

| | | | | | | | |
|---|---|---|---|---|---|---|---|
| | Message | Message | | Device | | Status | Status |
| Version | Size I | Size II | Command | ID | MessageID | Code I | Code II |

| | | | | | |
|---|---|---|---|---|---|
| 00 | 00 | 00 | 00 | 02 | 01 |

Table 7 illustrates a power-up notification command message. This command is sent from the scanner to the handheld computing device whenever the scanner starts or restarts. No response is expected for this command. As shown in the table below, the command also requires no attached message.

TABLE 7

| | Message | Message | | | |
|---|---|---|---|---|---|
| Version | Size I | Size II | Command | Device ID | MessageID |
| 00 | 00 | 00 | 01 | 02 | 01 |

Table 8 illustrates a power-recycling command. This command is sent from the handheld computing device to the scanner to cause the scanner to recycle its power. In some embodiments, the recycle command causes the scanner to shut down. No response is expected but, as noted with respect to Table 7, the scanning device can send a power-up notification command to the handheld computing device when the scanner is powered up again.

TABLE 8

| | Message | Message | | | |
|---|---|---|---|---|---|
| Version | Size I | Size II | Command | Device ID | MessageID |
| 00 | 00 | 00 | 02 | 01 | 01 |

Table 9 illustrates a start-scan command, which is sent from the handheld computing device to the scanner and cause a barcode scan to start.

TABLE 9

| | Message | Message | | | |
|---|---|---|---|---|---|
| Version | Size I | Size II | Command | Device ID | MessageID |
| 00 | 00 | 00 | 03 | 01 | 01 |

Table 10 illustrates a response to a start-scan command, which response is sent from the scanning device and indicates to the handheld computing device that the scanning device has received the start-scan command. In some embodiments, this response is not needed and instead the handheld computing device can simply return the scanned data using the scanned-data command, as illustrated, for example, in Table 13.

TABLE 10

| | | | | | | | |
|---|---|---|---|---|---|---|---|
| | Message | Message | | Device | | Status | Status |
| Version | Size I | Size II | Command | ID | MessageID | Code I | Code II |

| | | | | | |
|---|---|---|---|---|---|
| 00 | 00 | 00 | 03 | 02 | 01 |

Table 11 illustrates an exemplary stop-scan command, which is sent from the handheld computing device to the scanning device to stop a barcode scan.

TABLE 11

| | Message | Message | | | |
|---|---|---|---|---|---|
| Version | Size I | Size II | Command | Device ID | MessageID |
| 00 | 00 | 00 | 04 | 01 | 01 |

Table 12 illustrates an exemplary response to the stop-scan command, which is sent from the scanning device to the handheld computing device to confirm that the stop-scan command has been received.

TABLE 12

| | | | | | | | |
|---|---|---|---|---|---|---|---|
| | Message | Message | | Device | | Status | Status |
| Version | Size I | Size II | Command | ID | MessageID | Code I | Code II |

| | | | | | |
|---|---|---|---|---|---|
| 00 | 00 | 00 | 04 | 02 | 01 |

Table 13 illustrates an exemplary scan result message, which is sent from the scanning device to the handheld computing device and contains the information that was scanned and decoded from the scanned barcode(s). The exemplary three-byte message, below, is used to send a scanned result of a 3-digit barcode with a value represented by the characters “000,” no response is expected. As illustrated in the table, the binary values 30, 30, 30 are converted to ASCII values 48, 48, 48, which corresponds to the characters 0,0,0. In some embodiments this message can be sent as a response to the start-scan command.

TABLE 13

| | | | | | | | | | | | |
|---|---|---|---|---|---|---|---|---|---|---|---|
| | | | | | | | Status | Bar | | | |
| | Message | Message | | Device | Message | Status | Code | Code | | | |
| Version | Size I | Size II | Command | ID | ID | Code I | II | Type | BCD | BCD | BCD |

| | | | | | | | | |
|---|---|---|---|---|---|---|---|---|
| 00 | 00 | 03 | 05 | 02 | 01 | 30 | 30 | 30 |

Table 14 illustrates an exemplary scanner button state command message, which is sent from the scanner to the handheld computing device to inform the handheld computing device of the status of the scanner button. In some embodiments, the scanner can have a manual scanner activation in the form of a button. The command illustrated in Table 14 returns the status of the scanner activation button. As illustrated in Table 14, this message is a one-byte message that is sent from the scanner and that indicates that the scanner button is depressed (button state value 01=scanner button depressed; button state value 00=scanner button not depressed). No response is expected from the handheld computing device.

TABLE 14

| | Message | Message | Com- | Device | | Button |
|---|---|---|---|---|---|---|
| Version | Size I | Size II | mand | ID | MessageID | State |
| 00 | 00 | 01 | 06 | 02 | 01 | 01 |

Table 15 illustrates an exemplary scanner-time-out-configuration command, which is sent from the handheld computing device to the scanning device to configure the scanner to timeout or “go to sleep” after a specified period of inactivity. This exemplary message has a size of two bytes and specifies that the scanner should timeout after 600 seconds of inactivity. Note that the config byte 1 field and the config byte 2 field are read together to indicate the hexadecimal value 0258, corresponding to 600 seconds in decimal value. The config set/get field operates as a read/write command. A value of 00 instructs the scanner to set the configuration. A value of 01, as shown in Table 17, instructs the scanner to get its current setting and report it back to the handheld computing device.

TABLE 15

| | | | | | | | Config | Config |
|---|---|---|---|---|---|---|---|---|
| | Message | Message | | Device | | Config | Byte 1 | Byte 2 |
| Version | Size i | Size ii | Command | ID | MessageID | set/get | (Seconds | (Seconds) |
| 00 | 00 | 02 | 07 | 01 | 01 | 00 | 02 | 58 |

Table 16 illustrates an exemplary response to the scanner-time-out-configuration command. The scanning device can send back a response confirming that the new configuration for the scanner-time-out-configuration command is 600 seconds. In this example, the scanning device also sent back a status code 04 corresponding to the auto answer status presented in Table 3.

TABLE 16

| | | | | | | Status | Status | Config | Config |
|---|---|---|---|---|---|---|---|---|---|
| | Message | Message | | Device | | Code | Code | Byte 1 | Byte 2 |
| Version | Size i | Size ii | Command | ID | MessageID | Byte 1 | Byte 2 | (Seconds | (Seconds) |
| 00 | 00 | 02 | 07 | 02 | 01 | 04 | 00 | 02 | 58 |

Similarly, Tables 17 and 18 illustrate the same command, i.e., the scanner-time-out-configuration, but this time the handheld computing device requests the scanning device to report its current configuration setting (Table 17) and the scanning device provides its reply (Table 18). It should be noted that the config set/get field value is now set to 01, which indicates that this is a get command as opposed to the set command explained with reference to table 16.

TABLE 17

| | Message | Message | Com- | Device | | Config |
|---|---|---|---|---|---|---|
| Version | Size i | Size ii | mand | ID | MessageID | set/get |
| 00 | 00 | 01 | 07 | 01 | 01 | 01 |

TABLE 18

| | | | | | | Status | Status | Config | Config |
|---|---|---|---|---|---|---|---|---|---|
| | Message | Message | | Device | | Code | Code | Byte 1 | Byte 2 |
| Version | Size i | Size ii | Command | ID | MessageID | Byte 1 | Byte 2 | (Seconds | (Seconds) |
| 00 | 00 | 02 | 07 | 02 | 01 | 04 | 00 | 02 | 58 |

Table 19 illustrates another exemplary configuration command. This command, the scan timeout command, is used to set the scan timeout of barcode scanner's laser as opposed to the timeout of the scanning device in the scanner timeout command. In this example, the scanner device is commanded to configure its laser to timeout after 15 seconds.

TABLE 19

| | Message | Message | | Device | | Config | Config |
|---|---|---|---|---|---|---|---|
| Version | Size i | Size ii | Command | ID | MessageID | set/get | (Seconds) |
| 00 | 00 | 02 | 08 | 01 | 01 | 00 | 0F |

Table 20 illustrates an exemplary response to the scan-time-out-configuration command, which confirms that the configuration has been set.

TABLE 20

| | | | | | | Status | Status | |
|---|---|---|---|---|---|---|---|---|
| | Message | Message | | Device | | Code | Code | Config |
| Version | Size i | Size ii | Command | ID | MessageID | Byte 1 | Byte 2 | (Seconds) |
| 00 | 00 | 01 | 08 | 02 | 01 | 04 | 00 | 0F |

Tables 21 and 22 illustrate the same command, viz., the scan-time-out-configuration, but this time the handheld computing device requests the scanning device to report its current configuration setting (Table 21) and the scanning device provides its reply (Table 22). It should be noted that the config set/get field value is now set to 01, which indicates that this is a get command as opposed to the set command explained with reference to table 19.

TABLE 21

| | Message | Message | Com- | Device | | Config |
|---|---|---|---|---|---|---|
| Version | Size i | Size ii | mand | ID | MessageID | set/get |
| 00 | 00 | 01 | 08 | 01 | 01 | 01 |

TABLE 22

| | | | | | | Status | Status | |
|---|---|---|---|---|---|---|---|---|
| | Message | Message | | Device | | Code | Code | Config |
| Version | Size ii | Size | Command | ID | MessageID | Byte 1 | Byte 2 | (Seconds |
| 00 | | 01 | 08 | 02 | 01 | 04 | 00 | 0F |

Table 23 illustrates another exemplary configuration command, viz., the scan mode command, which is used to configure the scanner for single or multiscan mode. Single scan mode configures the scanning device to only accept one barcode in any scanning operation, while multiscan mode configures the scanning device to accept multiple barcodes in the same scanning operation. The value “00” in the Config (Scan Mode) field designates single scan mode, while a value of “01” would represent multiscan mode. Additionally, as described above with respect to the other configuration commands, the scan-mode command also uses the same values in the Config set/get field to instruct the scanning device to either set the configuration or to report the currently set configuration.

TABLE 23

| | | | | | | | Config |
|---|---|---|---|---|---|---|---|
| | Message | Message | | Device | | Config | (Scan |
| Version | Size i | Size ii | Command | ID | MessageID | set/get | Mode) |
| 00 | 00 | 02 | 09 | 01 | 01 | 00 | 00 |

Table 24 illustrates an exemplary response to the scan mode command, which confirms that the scan-mode command has been received.

TABLE 24

| | | | | | | Status | Status | Config |
|---|---|---|---|---|---|---|---|---|
| | Message | Message | | Device | | Code | Code | (Scan |
| Version | Size i | Size ii | Command | ID | MessageID | Byte 1 | Byte 2 | Mode) |
| 00 | 00 | 01 | 09 | 02 | 01 | 04 | 00 | 00 |

Table 25 illustrates an exemplary scan mode command, wherein the scan mode is being set to multiscan mode.

TABLE 25

| | | | | | | | Config |
|---|---|---|---|---|---|---|---|
| | Message | Message | | Device | | Config | (Scan |
| Version | Size i | Size ii | Command | ID | MessageID | set/get | Mode) |
| 00 | 00 | 02 | 09 | 01 | 01 | 00 | 01 |

Table 26 illustrates an exemplary response to the scan mode command described in Table 25.

TABLE 26

| | | | | | | Status | Status | |
|---|---|---|---|---|---|---|---|---|
| | Message | Message | | Device | | Code | Code | Config |
| Version | Size i | Size | Command | ID | MessageID | Byte 1 | Byte 2 | (Scan Mode) |
| 00 | 00 | 01 | 09 | 02 | 01 | 04 | 00 | 01 |

Similarly, Tables 27 and 28 illustrates the same command, viz., the scan mode configuration, but this time the handheld computing device requests the scanning device to report its current configuration setting (Table 27) and the scanning device provides its reply (Table 28). It should be noted that the config set/get field value is now set to 01, which indicates that this is a get command as opposed to the set command. In this example, the scanning device provides a response indicating that the scanning device is set to multiscan mode.

TABLE 27

| | Message | Message | Com- | Device | | Config |
|---|---|---|---|---|---|---|
| Version | Size i | Size ii | mand | ID | MessageID | set/get |
| 00 | 00 | 01 | 09 | 01 | 01 | 01 |

TABLE 28

| | | | | | | Status | Status | Config |
|---|---|---|---|---|---|---|---|---|
| | Message | Message | | Device | | Code | Code | (Scan |
| Version | Size i | Size ii | Command | ID | MessageID | Byte 1 | Byte 2 | Mode) |
| 00 | 00 | 01 | 09 | 02 | 01 | 04 | 00 | 01 |

Table 29 illustrates an exemplary configure-scan-button-status command, which enables or disables the scanning device's scan button. In this example a config (enable/disable) value of 00 disables the scanner's button.

TABLE 29

| | Message | Message | | Device | | Config | Config |
|---|---|---|---|---|---|---|---|
| Version | Size i | Size ii | Command | ID | MessageID | set/get | (enable/disable) |
| 00 | 00 | 02 | 0A | 01 | 01 | 00 | 00 |

Table 30 illustrates an exemplary response to the scan-button-status command illustrated in Table 29.

TABLE 30

| | | | | | | Status | Status | |
|---|---|---|---|---|---|---|---|---|
| | Message | Message | | Device | | Code | Code | Config |
| Version | Size i | Size ii | Command | ID | MessageID | Byte 1 | Byte 2 | (Seconds) |
| 00 | 00 | 01 | 0A | 02 | 01 | 04 | 00 | 00 |

Table 31 illustrates an exemplary scan-button-status command, by means of which the scan button is set to enabled.

TABLE 31

| | Message | Message | | Device | | Config | Config |
|---|---|---|---|---|---|---|---|
| Version | Size i | Size ii | Command | ID | MessageID | set/get | (enable/disable) |
| 00 | 00 | 02 | 0A | 01 | 01 | 00 | 01 |

Table 32 illustrates an exemplary response to the scan-button-status command described in Table 31.

TABLE 32

| | | | | | | Status | Status | |
|---|---|---|---|---|---|---|---|---|
| | Message | Message | | Device | | Code | Code | Config |
| Version | Size i | Size ii | Command | ID | MessageID | Byte 1 | Byte 2 | (Seconds) |
| 00 | 00 | 01 | 0A | 02 | 01 | 04 | 00 | 01 |

Tables 33 and 34 illustrate the same command, viz., the scan-button-status configuration, but this time the handheld computing device requests the scanning device to report its current configuration setting (Table 33) and the scanning device provides its reply (Table 34). It should be note that the config set/get field value is now set to 01, which indicates that this is a get command as opposed to the set command. In this example, the scanning device provides a response indicating that the scanning device button is enabled.

TABLE 33

| | Message | Message | Com- | Device | | Config |
|---|---|---|---|---|---|---|
| Version | Size i | Size ii | mand | ID | MessageID | set/get |
| 00 | 00 | 01 | 0A | 01 | 01 | 01 |

TABLE 34

| | | | | | | Status | Status | |
|---|---|---|---|---|---|---|---|---|
| | Message | Message | | Device | | Code | Code | Config |
| Version | Size i | Size ii | Command | ID | MessageID | Byte 1 | Byte 2 | (enable/disable) |
| 00 | 00 | 01 | 0A | 02 | 01 | 04 | 00 | 01 |

Table 35 illustrates an exemplary beep-configuration command, which is used to set the beep configuration of the scanning device, including whether a beep is enabled, its volume, and type of tone. In this example, a config (enable/disable) value of 01 enables the scanner's beep. A value of 00 disables the scanners beep. The scanner can provide a beep or tone after each barcode is scanned or after data is read by a magnetic card reader. In some embodiments, a beep is only emitted when meaningful data is read, e.g., a when a recognized barcode is read a beep is emitted, but when an unrecognized barcode is read, no beep is made. The beep serves to improve the user experience by informing the user that a barcode was successfully scanned. In this example, beep features, volume, tone, and duration can also be configured. The volume adjusts how loud the beep is and the value in this field can be either a relative scale of possible volumes, for example volumes from 1-10, or it can be a relative measure of volume, for example a value corresponding to a decibel level. The tone can designate one of several available tones to be used. Duration can specify the length for which the tone is to play. As illustrated in the table below, a value can be a duration measured in milliseconds.

TABLE 35

| | Message | Message | | Device | | Config | | | | | Duration | Duration |
|---|---|---|---|---|---|---|---|---|---|---|---|---|
| Version | Size i | Size ii | Command | ID | MessageID | set/get | Enable/Disable | Volume | Tone I | Tone II | (ms) | (ms) |
| 00 | 00 | 07 | 0B | 01 | 01 | 00 | 01 | XX | XX | XX | XX | XX |

Table 36 illustrates an exemplary response to the beep-configuration command illustrated in Table 35.

TABLE 36

| | | | | | | Status | Status | | | | | | |
|---|---|---|---|---|---|---|---|---|---|---|---|---|---|
| | Message | Message | | Device | | Code | Code | Enable/ | | | | Duration | Duration |
| Version | Size i | Size ii | Command | ID | MessageID | Byte 1 | Byte 2 | Disable | Volume | Tone I | Tone II | (ms) | (ms) |
| 00 | 00 | 06 | 0B | 02 | 01 | 04 | 00 | 01 | XX | XX | XX | XX | XX |

Table 37 illustrates an exemplary beep configuration command, wherein the beep is disabled.

TABLE 37

| | Message | Message | | Device | | Config | Enable/ |
|---|---|---|---|---|---|---|---|
| Version | Size i | Size ii | Command | ID | MessageID | set/get | Disable |
| 00 | 00 | 00 | 0B | 01 | 01 | 00 | 00 |

Table 38 illustrates a response to the exemplary beep configuration command, wherein the beep is disabled illustrated in Table 37.

TABLE 38

| | Message | Message | | Device | Message | Status | Status | Enable/ |
|---|---|---|---|---|---|---|---|---|
| Version | Size I | Size II | Command | ID | ID | Code 1 | Code 2 | Disable |
| 00 | 00 | 00 | 0B | 02 | 01 | 04 | 00 | 00 |

Tables 39 and 40 illustrate the same command, viz. the beep configuration command, but this time the handheld computing device requests the scanning device to report its current configuration setting (Table 39) and the scanning device provides its reply (Table 40). It should be noted that the config set/get field value is now set to 01, which indicates that this is a get command as opposed to the set command. In this example, the scanning device provides a response indicating that the scanning device beep is enabled.

TABLE 39

| | Message | Message | Com- | Device | | Config |
|---|---|---|---|---|---|---|
| Version | Size i | Size ii | mand | ID | MessageID | set/get |
| 00 | 00 | 01 | 09 | 01 | 01 | 01 |

TABLE 40

| | | | | | | Status | Status | | | | | | Duration |
|---|---|---|---|---|---|---|---|---|---|---|---|---|---|
| | Message | Message | | Device | | Code | Code | Enable/ | | | | Duration | II |
| Version | Size i | Size ii | Command | ID | MessageID | Byte 1 | Byte 2 | Disable | Volume | Tone I | Tone II | (ms) | (ms) |
| 00 | 00 | 06 | 09 | 01 | 01 | 04 | 00 | XX | XX | XX | XX | XX | XX |

Table 41 illustrates an exemplary barcode type command. In some embodiments, the type of barcode symbology to be scanned is known, and in such embodiments it can be useful to tell the scanner what barcode symbology it will be scanning as this can save processing resources for the scanner. In such embodiments, wherein the barcode symbology is known, the barcode-type command can set the scanner such that only expected barcode symbologies are enabled.

One the other hand, in many instances a barcode symbology is not known, and the barcode-type command can set the scanner to enable all barcodes. In such embodiments, the barcode-scanning device has an algorithm that can determine a scanned barcode symbology and decode the barcode automatically if the scanned barcode has one of the recognized symbologies.

In table 41, below, the barcode-type command is being used to enable all barcode types as determined by the config set/get field having a value 00. Values of 01, 02, and 03 represent “set disable,” “get barcode status,” and “get all barcodes supported,” respectively. The values in the barcode-type field correspond to the values listed in Table 4. Thus, in Table 41, below, all barcode types have been enabled.

TABLE 41

| | Message | Message | | Device | | Config | BarCode |
|---|---|---|---|---|---|---|---|
| Version | Size i | Size ii | Command | ID | MessageID | set/get | Type |
| 00 | 00 | 02 | 0C | 01 | 01 | 00 | 00 |

Table 42 illustrates one possible response to the barcode-type command. In table 42, the message size is 5 bytes, or 40 bits. The message size requires 35 bits to report that 35 barcodes are enabled. The first 5 bits can be ignored. In this example, each barcode is assigned a bit value. If a particular type of barcode is enabled, it will be represented by a 1 in the corresponding bit position. For example, if a UPC barcode symbology is to be reported and the UPC barcode is assigned to bit number 6, a value 1 in bit number 6 can indicate that the UPC barcode symbology is enabled.

TABLE 42

| | Message | Message | | | | Status | Status | | | | | |
|---|---|---|---|---|---|---|---|---|---|---|---|---|
| Version | Size i | Size ii | Command | Device ID | MessageID | Code 1 | Code II | BCT1 | BCT2 | BCT3 | BCT4 | BCT5 |
| 00 | 00 | 05 | 0C | 02 | 01 | 04 | 00 | 07 | FF | FF | FF | FF |

As illustrated in Table 42, the scanner responds that all 35 supported barcodes are enabled by listing the barcodes that are enabled in hexadecimal 07FFFFFFFF, which translates to 011111111111111111111111111111111111 in binary. Since the first 5 bits are always ignored, the response indicates that all barcodes are enabled because a 1 is represented in every bit position corresponding to a barcode. This is illustrated in Table 43, below, which illustrates all 40-bit positions. Positions 0-34 correspond to barcode symbologies.

TABLE 43

| 39 | 38 | 37 | 36 | 35 | 34 | 33 | 32 | 31 | 30 | 29 | 28 | 27 | 26 | 25 | 24 | 23 | 22 | 21 | 20 |
|---|---|---|---|---|---|---|---|---|---|---|---|---|---|---|---|---|---|---|---|
| 0 | 0 | 0 | 0 | 0 | 1 | 1 | 1 | 1 | 1 | 1 | 1 | 1 | 1 | 1 | 1 | 1 | 1 | 1 | 1 |
| 19 | 18 | 17 | 16 | 15 | 14 | 13 | 12 | 11 | 10 | 9 | 8 | 7 | 6 | 5 | 4 | 3 | 2 | 1 | 0 |
| 1 | 1 | 1 | 1 | 1 | 1 | 1 | 1 | 1 | 1 | 1 | 1 | 1 | 1 | 1 | 1 | 1 | 1 | 1 | 1 |

Table 44 illustrates the barcode-type command being used to retrieve all enabled barcodes. The barcode-type command is again represented by the hexadecimal value 0C, but in this example the config set/get field has the value, 02, which causes the scanning device to read out all barcode symbologies that are currently enabled. Other values that can be given using this field include a disable configuration, 01, which will cause the scanning device to no longer recognize the listed barcode symbologies, and the get-all-barcode-symbolgies-supported configuration, 03, which causes the scanning device to return a list of all barcode symbologies that the scanning device will recognize, if enabled.

TABLE 44

| | Message | Message | Com- | Device | | Config |
|---|---|---|---|---|---|---|
| Version | Size i | Size ii | mand | ID | MessageID | set/get |
| 00 | 00 | 01 | 0C | 01 | 01 | 02 |

Table 45 illustrates a response to the message illustrates in Table 44. In table 45, the message size is 5 bytes or 40 bits. The message size requires 35 bits to report that 35 barcodes are enabled. The first 5 bits can be ignored. In this example, each barcode is assigned a bit value. If the barcode is enabled, it will be represented by a 1 in that bit position. For example, if a UPC barcode symbology is to be reported and the UPC barcode is assigned to bit number 6, a 1 in bit number 6 can indicate that the UPC barcode symbology is enabled.

TABLE 45

| | Message | Message | | | | Status | Status | | | | | |
|---|---|---|---|---|---|---|---|---|---|---|---|---|
| Version | Size i | Size ii | Command | Device ID | MessageID | Code 1 | Code II | BCT1 | BCT2 | BCT3 | BCT4 | BCT5 |
| 00 | 00 | 05 | 0C | 01 | 01 | 04 | 00 | 07 | FF | FF | FF | FF |

As above, the hexadecimal value 07FFFFFFFF translates to 011111111111111111111111111111111111 in binary. Since the first 5 bits are always ignored, the response indicates that all barcodes are enabled because a 1 is represented in every bit position corresponding to a barcode. This is illustrated in Table 46, below, which illustrates all 40-bit positions. Positions 0-34 correspond to barcode symbologies.

TABLE 46

| 39 | 38 | 37 | 36 | 35 | 34 | 33 | 32 | 31 | 30 | 29 | 28 | 27 | 26 | 25 | 24 | 23 | 22 | 21 | 20 |
|---|---|---|---|---|---|---|---|---|---|---|---|---|---|---|---|---|---|---|---|
| 0 | 0 | 0 | 0 | 0 | 1 | 1 | 1 | 1 | 1 | 1 | 1 | 1 | 1 | 1 | 1 | 1 | 1 | 1 | 1 |
| 19 | 18 | 17 | 16 | 15 | 14 | 13 | 12 | 11 | 10 | 9 | 8 | 7 | 6 | 5 | 4 | 3 | 2 | 1 | 0 |
| 1 | 1 | 1 | 1 | 1 | 1 | 1 | 1 | 1 | 1 | 1 | 1 | 1 | 1 | 1 | 1 | 1 | 1 | 1 | 1 |

If one or more barcodes are to be disabled, the message illustrated in Table 47 is can be sent. The message indicates that the barcode-type command (command 0C) is being sent, and that the scanner is being configured to disable (Config 01) barcode type 04.

TABLE 47

| | Message | Message | | | | Config | BarCode |
|---|---|---|---|---|---|---|---|
| Version | Size i | Size ii | Command | Device ID | MessageID | set/get | Type |
| 00 | 00 | 02 | 0C | 01 | 01 | 01 | 04 |

Table 48, illustrates the scanners response indicating that it has received the new configuration by reading back the currently enabled barcodes. Instead of reporting that all barcodes are enabled, as above, the scanning device reports that the barcodes corresponding to the bit positions having a “1” listed in binary positions translated from the hexadecimal value 07FFFFFFF7 are enabled.

TABLE 48

| | | | | | | | Status | | | | | |
|---|---|---|---|---|---|---|---|---|---|---|---|---|
| | Message | Message | | Device | | Status | Code | | | | | |
| Version | Size i | Size ii | Command | ID | MessageID | Code I | II | Byte 1 | 2 | 3 | 4 | 5 |
| 00 | 00 | 05 | 0C | 02 | 01 | 04 | 00 | 07 | FF | FF | FF | F7 |

As illustrated in Table 49, all barcodes except for barcode 4, which is identified in position 3, are enabled.

TABLE 49

| 39 | 38 | 37 | 36 | 35 | 34 | 33 | 32 | 31 | 30 | 29 | 28 | 27 | 26 | 25 | 24 | 23 | 22 | 21 | 20 |
|---|---|---|---|---|---|---|---|---|---|---|---|---|---|---|---|---|---|---|---|
| 0 | 0 | 0 | 0 | 0 | 1 | 1 | 1 | 1 | 1 | 1 | 1 | 1 | 1 | 1 | 1 | 1 | 1 | 1 | 1 |
| 19 | 18 | 17 | 16 | 15 | 14 | 13 | 12 | 11 | 10 | 9 | 8 | 7 | 6 | 5 | 4 | 3 | 2 | 1 | 0 |
| 1 | 1 | 1 | 1 | 1 | 1 | 1 | 1 | 1 | 1 | 1 | 1 | 1 | 1 | 1 | 1 | 0 | 1 | 1 | 1 |

Table 50 illustrates an exemplary check-battery-status command, which is used to get the battery status, e.g., remaining power available or percentage of battery life remaining, from the scanning device.

TABLE 50

| | Message | Message | | | |
|---|---|---|---|---|---|
| Version | Size i | Size ii | Command | Device ID | MessageID |
| 00 | 00 | 00 | 0E | 01 | 01 |

Table 51 illustrates an exemplary response to the check-battery-status command, which returns a battery status in the form of a voltage from the scanning device. The “XX” in the voltage cells are variables.

TABLE 51

| | | | | | | Status | Status | | |
|---|---|---|---|---|---|---|---|---|---|
| | Message | Message | | Device | | Code | Code | | Voltage |
| Version | Size i | Size ii | Command | ID | MessageID | Byte 1 | Byte 2 | Voltage I | II |
| 00 | 00 | 01 | 0E | 02 | 01 | 04 | 00 | XX | XX |

Table 52 illustrates an exemplary firmware-version status command, which returns the current version number for the firmware installed of the scanning device.

TABLE 52

| | Message | Message | | | |
|---|---|---|---|---|---|
| Version | Size i | Size ii | Command | Device ID | MessageID |
| 00 | 00 | 00 | 0D | 01 | 01 |

Table 53 illustrates an exemplary response to the firmware-version status command illustrates in Table 52. In this table, the scanning device has returned a value of 01, thus indicating that the scanning device is running version 1 of the firmware.

TABLE 53

| | | | | | | Status | Status | |
|---|---|---|---|---|---|---|---|---|
| | Message | Message | | Device | | Code | Code | Firmware |
| Version | Size i | Size ii | Command | ID | MessageID | Byte 1 | Byte 2 | Version |
| 00 | 00 | 01 | 0D | 02 | 01 | 04 | 00 | 01 |

In some embodiments, the firmware version status can be given every time the handheld computing device is attached to the scanning device via a connector, or the handheld device can request the version status with regular frequency. Checking for the firmware version ensures that both devices are receiving communications that they are configured to understand by having both devices use compatible versions of their software. It also enables the handheld computing device to update the firmware on the scanning device when it is required.

Where the handheld computing device is used to update the firmware on the scanning device, the handheld computing device can issue such a command in the command field, which will prepare the scanning device to receive data from the handheld computing device; to install the new firmware; and restart the scanning device as appropriate.

It should be understood that many of the commands discussed above specifically relate to the barcode scanning capabilities of the scanning device, but similar commands can also be issued to operate the magnetic strip reader. For example, a command analogous to the start-scan command can be used to start reading data from the magnetic strip reader. For example a start-payment scan command can cause the scanning device to read a payment card. The magnetic strip reader can also be set to timeout after a certain period of time with a command analogous to the scan-timeout command. The scanning device can send a magnetic strip reader data message, which can designate the size of a message and include numerical values associated with a payment card that has been read, (e.g., a credit card or bankcard) as the message. For example, the scanner can send a scanned-payment-data message to report data read from the payment card. In some embodiments, the scanner can send multiple different messages back to the handheld computing device, including expiration date information, customer information, or any other information read from the card. Alternatively, all of the data can be sent in the same message.

In some embodiments the operation of the magnetic strip reader can be initiated from the scanning device itself. When a payment card is swiped through the magnetic strip reader, the magnetic strip reader can read the payment card without first receiving a command from the handheld computing device to prepare to receive the data. In such embodiments, the scanning device can send a scanned-payment-data message to the handheld computing device accompanied by the payment card data.

The scanning device firmware can require the scanning device to receive an instruction from the handheld computing device to send designated data values, or the scanning device can be directed by its firmware to send the data values in response to reading a swiped card without first being prompted to do so.

In some embodiments, the scanning device can also receive configuration commands to accept only certain types of credit cards, e.g., VISA, MASTERCARD, AMERICAN EXPRESS, DISCOVER, etc., or it can be configured to receive all types of credit cards. The handheld computing device and the scanning device can be configured to communicate with each other to configure, operate and/or get status of the magnetic strip reader in a manner analogous to that described above with respect to the barcode scanner.

The protocol described herein can be particularly useful in the context of facilitating communication between a scanner and a handheld computing device when used as a roaming point-of-sale system for completing retail sale transactions. In some embodiments, the handheld computing device can configure the scanning device to scan barcodes using designated barcode symbologies, one at a time, or multiple barcodes scanned in the same scanning operation.

In one example, a customer can desire to purchase a mobile telephone. A sales associate can use the portable computing device of the roaming point-of-sale system to initiate a scan of a barcode on the mobile phone packaging. Using the protocol described herein, the handheld computing device can issue a start-scan command to the scanning device. The scanning device can scan the barcode on the mobile phone packaging and return the code encoded by the barcode to the handheld computing device using the scanned data command.

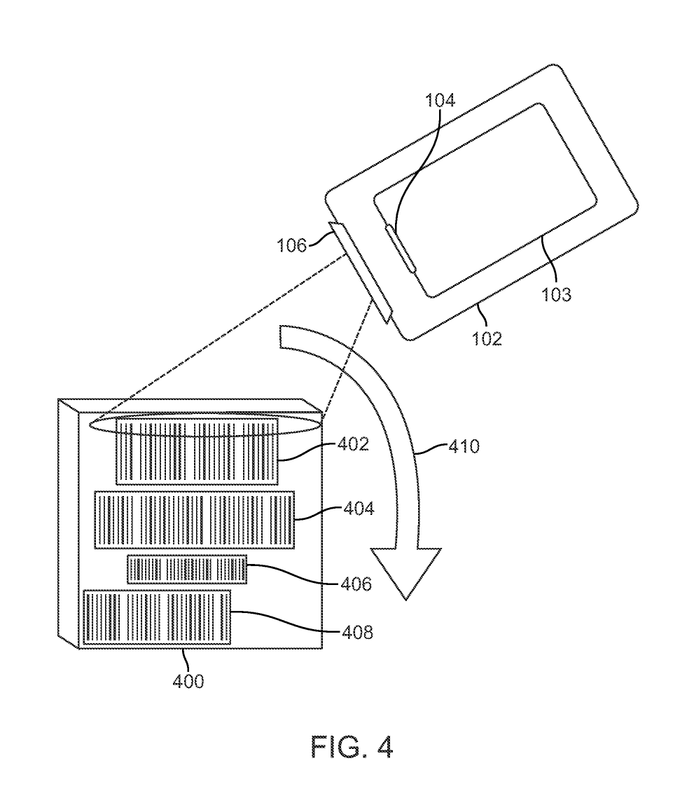

As illustrated in FIG. 4, the methods and protocol for operating the roaming point of sale system described herein are particularly useful in a retail environment, wherein a sales associate can complete a sales transaction using the system. A product package 400 containing multiple barcodes representing different code types (402, 404, 406, 408) is illustrated. Barcode 402 represents the part number of the product or product code, barcode 404 represents the serial number of the product, barcode 406 represents the IMEI number of the product, and barcode 408 represents the ICCID number of the product. In some embodiments, each of the four codes can be encoded by different barcode symbologies.

As illustrated in FIG. 4 a scanner can scan every barcode on the package in one scanning or swiping motion or at least in a single scanning operation. In some embodiments the scanning device can provide a tone or visual confirmation such as a flashing LED for each barcode scanned so that a sales associate can receive confirmation that the desired number of bar codes has been scanned. While in some embodiments a computing device, such as the portable electronic device 103, can store and provide access to a form or database to be completed with information extracted from the barcodes and can also provide a tone or visual confirmation that the appropriate barcodes were scanned and the desired information was received into the form.

As a sales associate scans each barcode on the product, usually in one continuous motion, the scanner device 102 can scan all four barcodes 402, 404, 406, and 408 in one swipe as shown by arrow 410, even though the barcodes are not necessarily in the same, consistent symbology. Once the four barcodes 402, 404, 406, and 408 are scanned, software subsequently determines the symbology of each barcode, decodes the barcodes and passes the decoded data to a program for completing the sales transaction.

In preferred embodiments, the algorithm(s) required to recognize a given barcode symbology can be part of the scanning device itself. As is known in the art, some barcode scanners are programmed with such algorithms, which allow the scanner to recognize and decode many different barcode symbologies. However, in some embodiments, such capability can be programmed into the portable communication device.

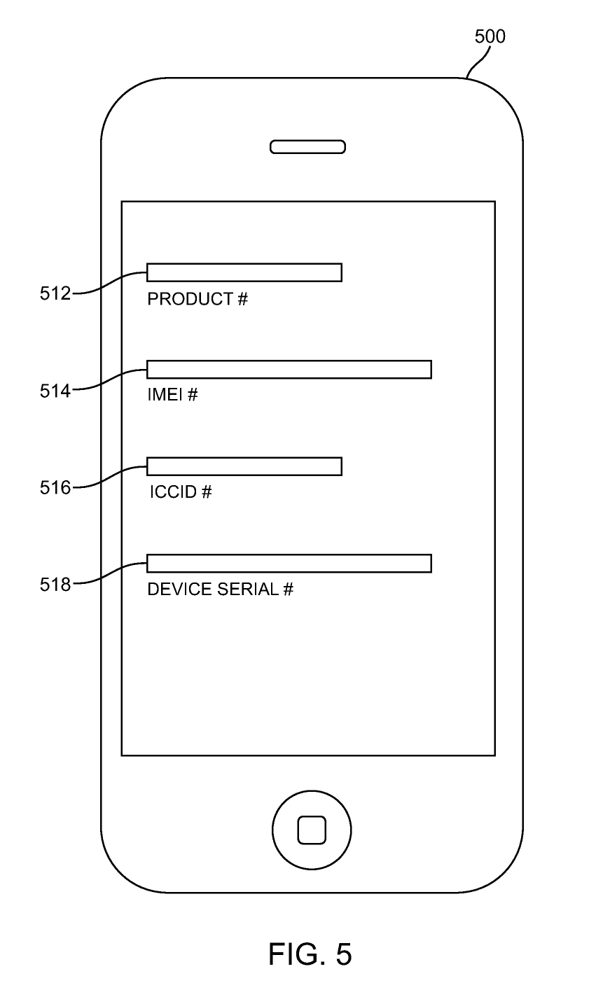

FIG. 5 illustrates a handheld computing device 500, displaying an exemplary sales form screen 510. In some embodiments, the sales form can have more or less fields, which need not be simultaneously displayed. Further, the screen 510 illustrated in FIG. 5, can be skipped and not displayed if all information is automatically populated. The form can be automatically populated by receiving the necessary data from the scanning device and by processing the information by the sales application, which can recognize and distinguish the received codes and insert them into the sales form. As illustrated, the sales form 510 includes fields for a product code 512, IMEI number 514, ICC ID number 516, and a device serial number 518.

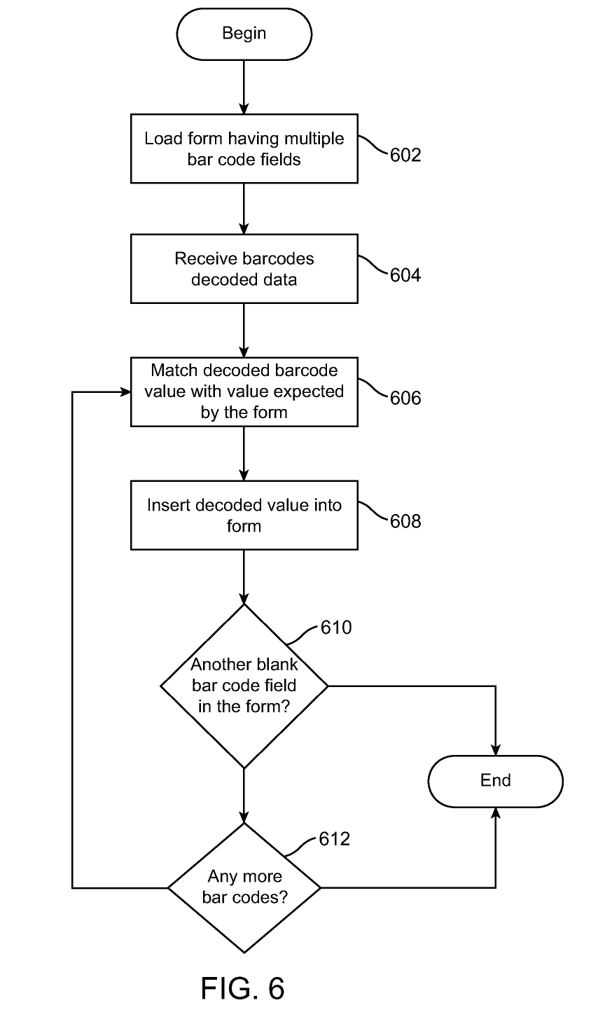

FIG. 6 illustrates an exemplary method of scanning multiple barcodes and inserting information decoded therefrom into a sales form or database. At 602 a sales form or database having a plurality of fields is loaded into the portable communication device's memory. In one example, the sales form requires several fields to be completed with information represented by a plurality of barcodes.

A plurality of barcodes, each encoding a different type of code, are scanned by the scanning device. Ideally the full complement of barcodes can be successfully scanned in one scan, as illustrated in FIG. 4. However, in some instances one or more of the barcodes can be rescanned to complete the set.

As is known with respect to conventional multi-barcode scanners, each barcode can be analyzed for a symbology match, using pattern-matching techniques. In some embodiments, the scanner can learn of the symbology of the barcode it is expecting before scanning the barcodes. In such embodiments, the expected symbologies can be or input into the scanner using the protocol described herein, and the scanner algorithm can compare the unknown barcodes with only the expected barcodes. While well upwards of 50 different barcode symbologies exist, processing resources can be conserved if the pattern matching software can be programmed to know the several expected barcode symbologies.

After the scanner decodes the barcodes, the data describing the decoded values can be received by the portable communication device (604).

In the example of a mobile telephone sale, the form can require a UPC code, device serial number, a IMEI code and a ICCID, as common examples. The portable communication device, which hosts the form, can analyze each decoded value received from the scanner to determine which of the decoded values is associated with each of the respective fields of the form (606). In the present example, each of the product code, serial number, IMEI code and the ICCID code are represented by values of a different number of characters. Accordingly, the routine can analyze one of the decoded values that was received from the scanner to determine the number of characters in the code and based on the number of characters the routine can determine which field of the form is associated with the value and insert the value into the form (608).

The routine can next determine if there is another blank field in the form (610) and if any more decoded barcode values are remaining to be analyzed (612). If it is determined that all fields are completed or that there are no more decoded barcode values to analyze, the routine ends. However, if the opposite is true, and there are additional decoded barcode values to analyze and blank fields remain to be completed by the routine, the method can return to 606 and the next value can be identified, and entered into the form (608).

Some product packaging can have more barcodes than are required by the sales form. In such instances, unrecognized values can simply be discarded and the next value processed until the routine completes by analyzing all of the barcodes or completing the form.

Barcodes can be processed one at a time as illustrated in FIG. 6, or they can be processed concurrently.

In some embodiments, if the method completes without satisfying every field in the form that requires barcode information, a message can be generated to inform an operator of the missing information. In such instances the operator can attempt to rescan the collection of barcodes, or just the required barcode, or the operator can type in the information, as in the instance of a poorly printed barcode.

As can be appreciated, the above-described method can greatly simplify a sales transaction for a device having multiple barcodes. Using the present technology, a sales associate can quickly scan several barcodes, which will be processed by the system, and automatically advance to processing payment and completing the transaction. This is in contrast to prior art technology which present a form to a sales associate and requires one barcode to be scanned at a time.

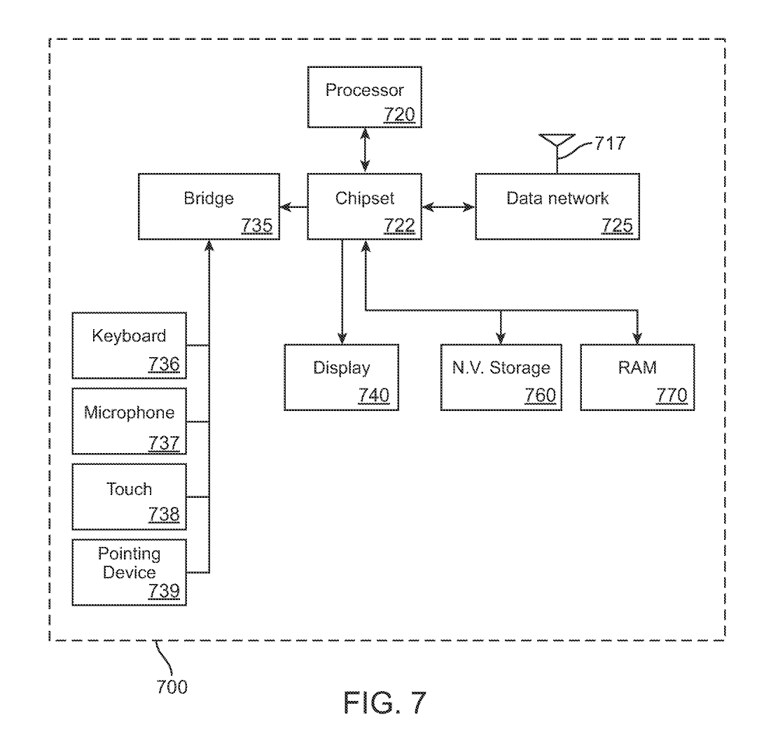

FIG. 7 illustrates a computer system 700 used to execute the sales application on the handheld computing device and to execute the method of communicating by the handheld computing device with the scanning device. Computer system 700 is an example of computer hardware, software, and firmware that can be used to implement the disclosures above. System 700 includes a processor 720, which is representative of any number of physically and/or logically distinct resources capable of executing software, firmware, and hardware configured to perform identified computations. Processor 720 communicates with a chipset 722 that can control input to and output from processor 720. In this example, chipset 722 outputs information to display 740 and can read and write information to non-volatile storage 760, which can include magnetic media and solid state media, for example. Chipset 722 also can read data from and write data to RAM 770. A bridge 735 for interfacing with a variety of user interface components can be provided for interfacing with chipset 722. Such user interface components can include a keyboard 736, a microphone 737, touch-detection-and-processing circuitry 738, a pointing device such as a mouse 739, and so on. In general, inputs to system 700 can come from any of a variety of machine-generated and/or human-generated sources.

Chipset 722 also can interface with one or more data network interfaces 725 that can have different physical interfaces 717. Such data network interfaces can include interfaces for wired and wireless local area networks, for broadband wireless networks, as well as personal area networks. Some applications of the methods for communicating with the scanning device disclosed herein can include receiving data over physical interface 717 or be generated by the machine itself by processor 720 analyzing data stored in memory 760 or 770. Further, the machine can receive inputs from the user via devices keyboard 736, microphone 737, touch device 738, and pointing device 739 and execute appropriate functions, such as browsing functions by interpreting these inputs using processor 720.

While FIG. 7 illustrates an example of a common system architecture, it should also be appreciated that other system architectures are known and can be used with the present technology. For example, systems wherein most or all of the components described within FIG. 7 can be joined to a bus, or the peripherals could write to a common shared memory that is connected to a processor or a bus can be used. Other hardware architectures are possible and such are considered to be within the scope of the present technology.

Methods according to the above-described examples can be implemented using computer-executable instructions that are stored or otherwise available from computer-readable media. Such instructions comprise, for example, instructions and data which cause or otherwise configure a general-purpose computer, a special-purpose computer, or a special-purpose processing device to perform a certain function or group of functions. Portions of computer resources used can be accessible over a network. The computer-executable instructions may be, for example, binaries, intermediate format instructions such as assembly language, firmware, or source code. Examples of computer-readable media that may be used to store instructions, information to be used, and/or information created during methods according to described examples include magnetic or optical disks, flash memory, USB devices provided with non-volatile memory, networked storage devices, and so on.

Devices implementing methods according to this disclosure can comprise hardware, firmware, and/or software and can take any of a variety of form factors. Typical examples of such form factors include laptops, smart phones, small-form-factor personal computers, personal digital assistants, and so on. Functionality described herein also can be embodied in peripherals or add-in cards. Such functionality also can be implemented on a circuit board among different chips or different processes executing in a single device, by way of further example.

The instructions, media for conveying such instructions, computing resources for executing them, and other structures for supporting such computing resources are means for providing the functions described in this disclosure.

Although a variety of examples and other information have been used to explain various aspects within the scope of the appended claims, no limitation of the claims should be implied based on particular features or arrangements in such examples, as one of ordinary skill would be able to use these examples to derive a wide variety of implementations. Furthermore, and although some subject matter may have been described in language specific to examples of structural features and/or method steps, it should be understood that the subject matter defined in the appended claims is not necessarily limited to those described features or acts. For example, functionality of the various components can be distributed differently or performed in components other than those identified herein. Therefore, the described features and steps are disclosed as examples of components of systems and methods that are deemed to be within the scope of the following claims.

1. A method of completing a retail sales transaction using a roaming point-of-sale system including a handheld computing device and a scanning device, the method comprising:
sending a start-scan command to the scanning device effective to cause the scanning device to scan a barcode on a product to be purchased;
receiving a scanned-data message from the scanning device, the scanned-data message having data describing at least a product code, the product code having been extracted from the scanned barcode; and
recording product information for a product associated with the product code and transaction information in a sales form on the handheld computing device.

2. The method of claim 1, further comprising:
receiving a scanned-payment-data message from the scanning device, the scanned-payment-data message having data read from a payment card.

3. The method of claim 1, wherein the transaction information includes payment information.

4. The method of claim 1, further comprising:
sending the product information and transaction information stored in the sales form to an in-store server.

5. The method of claim 1, further comprising:
configuring the scanning device by issuing a configuration command to the scanning device.

6. The method of claim 1, wherein the barcode is multiple barcodes each barcode encoding a different code.

7. The method of claim 6, wherein the different codes are one or more codes selected from group consisting of: an UPC code, an IMEI code, an ICCID code, and a serial number.

8. A method of operating a scanning device using a handheld computing device comprising:
sending commands from the handheld computing device to the scanning device, the commands having a header and appended data, the header including data fields for identifying a device type that is sending the message as one or more of a portable media-playing device and a smart phone, for designating a command type, for denoting a message size, and for identifying a message identification number, the command types available for designation comprising at least
a no-op command for detecting the presence of the scanning device,
a scan-mode configuration command for configuring the scanning device to scan multiple barcodes in a single scanning operation, or a single barcode in each scanning operation, and
a start-scan command for causing the scanning device to scan one or more barcodes according to the scan-mode configuration.

9. The method of claim 8, the commands further including:
a barcode-type command for designating one or more barcode symbologies to be enabled for scanning.

10. The method of claim 8, the commands further including:
an update-firmware command for causing firmware on the scanning device to be updated.

11. A roaming point-of-sale system comprising:
a handheld computing device including a processor configured to execute a sales application; and
a scanning device including a processor configured to execute firmware, a barcode scanner configured to scan and decode barcodes, and a magnetic strip reader configured to read payment card data,
the handheld computing device processor configured to send commands to the scanning device at the direction of the sales application, and to receive data from the scanning device for processing at the direction of the sales application,
the scanning device processor configured to receive commands from the handheld computing device and to process the commands, and to send data to the handheld computing device.

12. The system of claim 11, wherein the handheld computing device further includes a thirty-pin connector, and the scanning device further includes a complementary thirty-pin connector, both thirty-pin connectors configured to be in electrical connection with the other.

13. The system of claim 12, wherein the scanning device further includes a housing, the housing configured to receive the handheld computing device within a cavity such that the scanning device can receive the handheld computing device in a configuration that gives the appearance that the system is one integral device.

14. The system of claim 11, wherein the handheld computing device is a smart phone.

15. The system of claim 11, wherein the handheld computing device is a personal-media-playback device.

16. The system of claim 11, wherein the handheld computing device further includes a touch screen configured to receive inputs from a user effective to interact with the sales application.

17. A product comprising:
a machine-readable medium; and
machine-executable instructions for causing a computer to perform the method comprising
receiving a user input in a touchscreen input device effective to cause a first command to be sent to the scanning device effective to cause the scanning device to scan a barcode on a product to be purchased;
receiving data describing at least a product code, the product code having been extracted from the scanned barcode; and
recording product information for a product associated with the product code in a sales form on the handheld computing device.

18. The product of claim 17, further comprising:
receiving payment card data read from a payment card; and
recording the payment card data in the sales form.

19. The product of claim 18, further comprising:
sending the product information and transaction information stored in the sales form to an in-store server.

20. The product of claim 17, further comprising:
configuring the scanning device by issuing a configuration command to the scanning device.

21. The product of claim 17, wherein the barcode is multiple barcodes, each barcode encoding a different code.

22. The product of claim 21, wherein the different codes are one or more codes selected from group consisting of: a UPC code, an IMEI code, an ICCID code, and a serial number.

23. The product of claim 21 further comprising:
emitting a beep when a recognized barcode is scanned.
